(19) United States
(12) Patent Application Publication
(10) Pub. No.: US 2022/0237444 A1
(43) Pub. Date: Jul. 28, 2022

(54) WINDOWED CONTEXTUAL POOLING FOR OBJECT DETECTION NEURAL NETWORKS

(71) Applicant: Adobe Inc., San Jose, CA (US)

(72) Inventors: Curtis Michael Wigington, San Jose, CA (US); Laurie Marie Byrum, Pleasanton, CA (US)

(73) Assignee: Adobe Inc., San Jose, CA (US)

(21) Appl. No.: 17/158,639

(22) Filed: Jan. 26, 2021

(51) Int. Cl. G06N 3/08; G06N 3/04

(52) U.S. Cl. CPC G06N 3/08; G06N 3/04

(57) ABSTRACT

Techniques are disclosed for neural network based windowed contextual pooling. A methodology implementing the techniques according to an embodiment includes segmenting input feature channels into first and second groups of feature channels. The method also includes applying a first windowed pooling process to the first group of feature channels to generate a first group of pooled feature channels and applying a second windowed pooling process to the second group of feature channels to generate a second group of pooled feature channels. The method further includes performing a weighted merging of the first group of pooled feature channels and the second group of pooled feature channels to generate merged pooled feature channels. The method further includes concatenating the merged pooled feature channels with the input feature channels to generate concatenated feature channels and applying a two-dimensional convolutional neural network to the concatenated feature channels to generate contextually pooled output feature channels.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

This disclosure relates to document and image processing. Particularly, this disclosure relates to techniques for performing windowed contextual pooling (WCP) to detect objects in documents and images.

### BACKGROUND

Many object detection networks are implemented as fully convolutional neural networks (FCNs) which are configured to generate bounding boxes, detect, and classify objects that are spatially distributed throughout an image of a scene (e.g., objects depicted in an image of a desk or work area, such as a desk lamp, laptop, mouse and keyboard, briefcase or bag, and coffee cup). These FCNs typically have a limited receptive field (i.e., the area of the image that the FCN considers when making a prediction). As such, the FCN is unlikely to detect relatively large objects within the image. This can be particularly problematic when processing document images (as opposed to a natural image of a scene) which often have elements, such as tables, charts, figures, and lengthy paragraphs, that can span a significant portion of the width and/or height of the document image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an application of a neural network that employs windowed contextual pooling (WCP), in accordance with an embodiment of the present disclosure.

FIG. 2 is a block diagram of the neural network configured with WCP blocks, in accordance with an embodiment of the present disclosure.

FIG. 3 illustrates examples of windowed pooling, in accordance with an embodiment of the present disclosure.

FIG. 4 illustrates a color coded visualization of pooling operations, in accordance with an embodiment of the present disclosure.

FIG. 5 is a block diagram of an example embodiment of a WCP block, configured in accordance with an embodiment of the present disclosure.

FIG. 6 is a block diagram of another example embodiment of a WCP block, configured in accordance with an embodiment of the present disclosure.

FIG. 7 is a block diagram of yet another example embodiment of a WCP block, configured in accordance with an embodiment of the present disclosure.

FIG. 8 is a flowchart illustrating a method for performing WCP, in accordance with an embodiment of the present disclosure.

FIG. 9 is a block diagram schematically illustrating a computing platform configured to perform any of the techniques as variously described in this disclosure, in accordance with an embodiment of the present disclosure.

### DETAILED DESCRIPTION

Techniques are disclosed for utilizing windowed contextual pooling (WCP) in neural networks to provide improved object detection and classification. The techniques provide an efficient method for neural networks to increase their receptive field to be able to detect and classify larger objects within an image (i.e., objects that span relatively large regions of the image). The disclosed WCP techniques provide improved processing efficiency and reduced memory requirements compared to existing techniques that employ more computationally intensive long short-term memory (LSTM) networks to achieve larger receptive fields. As such, neural networks that implement the disclosed WCP techniques can be utilized on mobile platforms and other devices that have relatively limited computational and memory resources compared to a workstation or cloud-based server, although servers can also benefit from the increased speed and memory efficiency of these techniques. To this end, the techniques are particularly useful in mobile or other processor-constrained applications involving the detection and classification of objects of a document including a text component. However, and as will be further appreciated in light of this disclosure, the techniques can also readily be applied to, for instance, natural images of a scene, text-free documents or document images, workstation applications, and cloud-based server applications, and thus are not intended to be limited to document processing on mobile computing devices.

General Overview

As noted previously, FCNs that are used for image processing typically have a relatively narrow receptive field which limits their ability to detect and classify larger objects within an image. For example, an FCN with a receptive field of 128×128 operating on an image of 512×512 pixels would only be able to consider 6.25% of the input, for each output region. If an object in the image was larger than the 128×128 receptive field, it is unlikely the network would be able to recognize that object. This is particularly problematic when processing images of documents which often have elements, such as tables, charts, figures, and lengthy paragraphs, that can span a significant portion of the width and/or height of the document image. Additionally, documents often need to be processed at higher resolutions than natural images in order to capture fine details in elements such as text, and so a large receptive field becomes even more important. Existing technical solutions to increase the receptive field of a network are inadequate because they rely on techniques like LSTM which are inefficient or otherwise prohibitive from a computational and memory standpoint, particularly for use on mobile platforms. As such, an improved technical solution is needed.

Thus, techniques are provided herein for windowed contextual pooling for efficient, object detection and classification. These contextual pooling techniques improve the accuracy of document object detection and classification networks by increasing the context that the network can use to make a prediction. The context is increased by utilizing a combination of horizontal and vertical pooling layers of various types and of relatively large size (e.g., greater than 16). Note that the pooling operations employed by the disclosed techniques are used to increase context, unlike the pooling operations of existing networks which are used for down sampling (e.g., pooling two elements into one element).

So, according to an embodiment of the present disclosure, a methodology is provided for utilizing a WCP block in neural networks to provide improved object detection and classification for document images and scene images. In one example embodiment, the WCP block includes branching modules configured to segment input feature channels into different branches or groups of feature channels. The input feature channels may be generated by a backbone convolutional neural network (CNN) applied to an input image or they may be provided as the output of another WCP block (e.g., where multiple WCP blocks are stacked in a serial manner). The WCP block further includes pooling modules configured to apply a different windowed pooling process to each of the groups of feature channels. The pooling processes may include max pooling, min pooling, mean pooling, or any other desired type of pooling, and may be applied in the vertical or horizontal direction. Any suitable pooling kernel length may be used, but larger kernel sizes, for example greater than 16, provide more context. The WCP block further includes a merging module configured to perform a weighted merger of the pooled groups of feature channels. The WCP block further includes a concatenation module configured to concatenate the merged pooled feature channels with the input feature channels. The WCP block further includes a two-dimensional CNN configured to generate contextually pooled output feature channels which may be provided to another WCP block or to a CNN that is trained to detect and/or classify one or more objects in the input image. Many variations and embodiments will be appreciated in light of this disclosure.

Framework and System Architecture

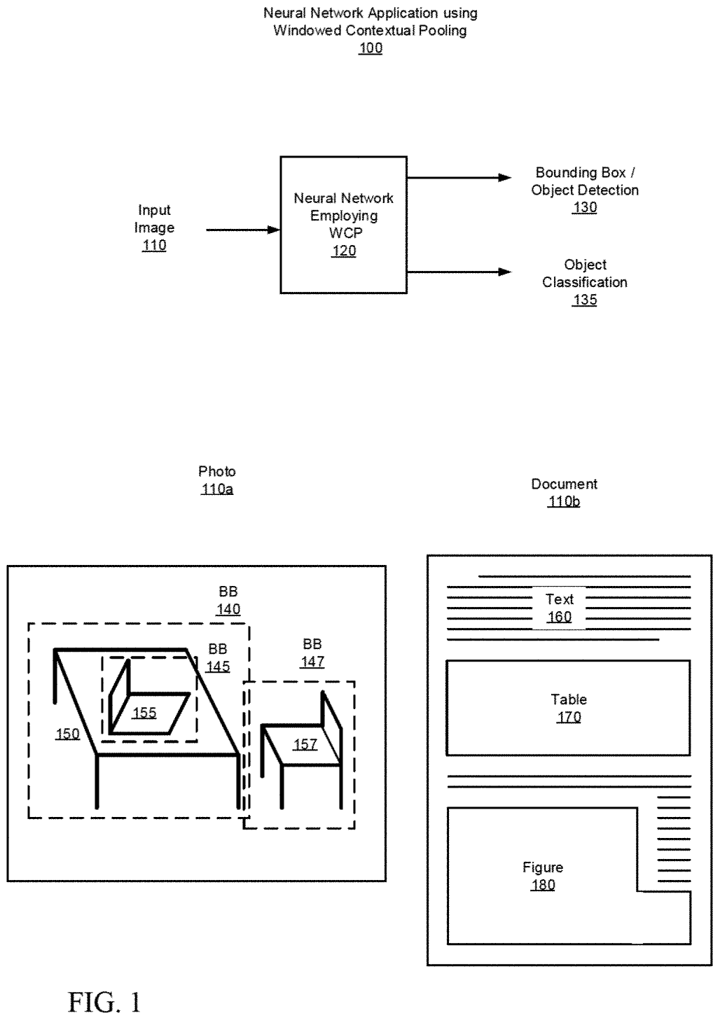

FIG. 1 illustrates an application 100 of a neural network that employs WCP, in accordance with an embodiment of the present disclosure. The neural network 120 is configured to analyze an input image 110 and generate bounding boxes or detections 130 of objects in the image and/or classify the objects. Input images may include photos, documents, or any other type of image. The input image includes one or more objects, and may or may not include a textual component.

An example photo image 110a is shown which includes a table 150, a laptop 150 resting on the table, and a chair 157. Some objects, such as the laptop, occupy a smaller region (e.g., a more local region) of the photo, while other objects, such as the table, occupy a larger region (e.g., a more global region) of the photo. Bounding boxes generated by the network 120 are also shown. For example, bounding box 140 encompasses the table and laptop, bounding box 145 encompasses just the laptop, and bounding box 147 encompasses the chair. The bounding boxes are typically generated as a first step in object detection and classification. It will be appreciated that a larger receptive field would be useful to detect and classify the table compared to the laptop.

An example document 110b is also shown which includes regions of text 160, a table 170 and a FIG. 180. The text, table, and figure all span relatively large (e.g., global) regions of the document page, taking up the entire width and a significant fraction of the height of the page. As such, a larger receptive field would be useful to detect and classify these components of the document. It will be appreciated that numerous other applications and examples are possible in light of the present disclosure.

Thus, the foregoing framework provides a system and methodology for utilizing windowed contextual pooling (WCP) to efficiently increase the receptive field of neural networks to provide improved object detection and classification of larger objects within an input image. Numerous example configurations and variations will be apparent in light of this disclosure.

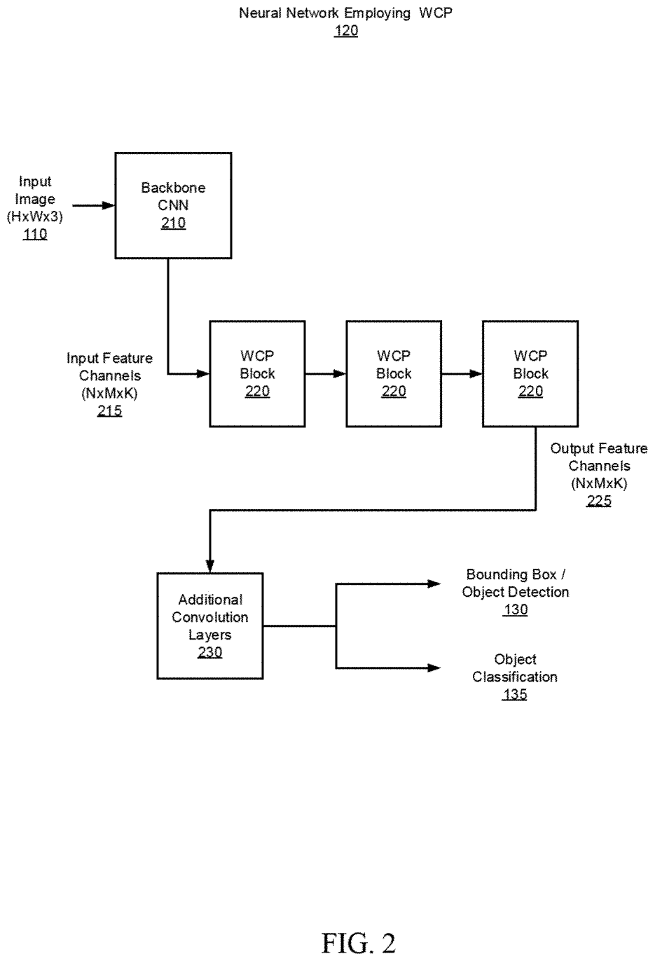

FIG. 2 is a block diagram of the neural network 120 configured with WCP blocks, in accordance with an embodiment of the present disclosure. The neural network 120 is shown to include a backbone CNN 210, three WCP blocks 220, and additional convolutional layers 230.

The backbone CNN 210 is configured as a feature extractor. The backbone CNN 210 accepts an input image 110 comprising an array of pixels. In some embodiments, the array is of height H pixels and width W pixels, wherein each pixel is represented by 3 color values (e.g., red, green, and blue). The backbone CNN 210 is configured (e.g., trained) to extract some number K of feature types from the image for use as input to the remaining components of the network. The features are represented as K channels 215, wherein each channel is an array of size N×M. N and M are the width and height of the output of the CNN 210 which generates each feature from regions of pixels of the input image. Any suitable method of feature extraction may be used in light of the present disclosure.

The WCP blocks 220 are configured to increase the receptive field of the neural network through windowed contextual pooling using a combination of horizontal and vertical pooling layers with relatively large pooling kernels, as will be explained below. Three WCP blocks 220 are shown in this figure, but any number of WCP blocks may be stacked together in serial fashion to increase accuracy, although at the expense of increased computation and a slower network.

The additional convolutional layers 230 are configured to generate the bounding boxes around objects, detect objects 130, and classify objects 135 in the image 110 using the contextually pooled features 225 provided by the WCP blocks 220. Any suitable convolutional network layers may be used for detection and classification in light of the present disclosure.

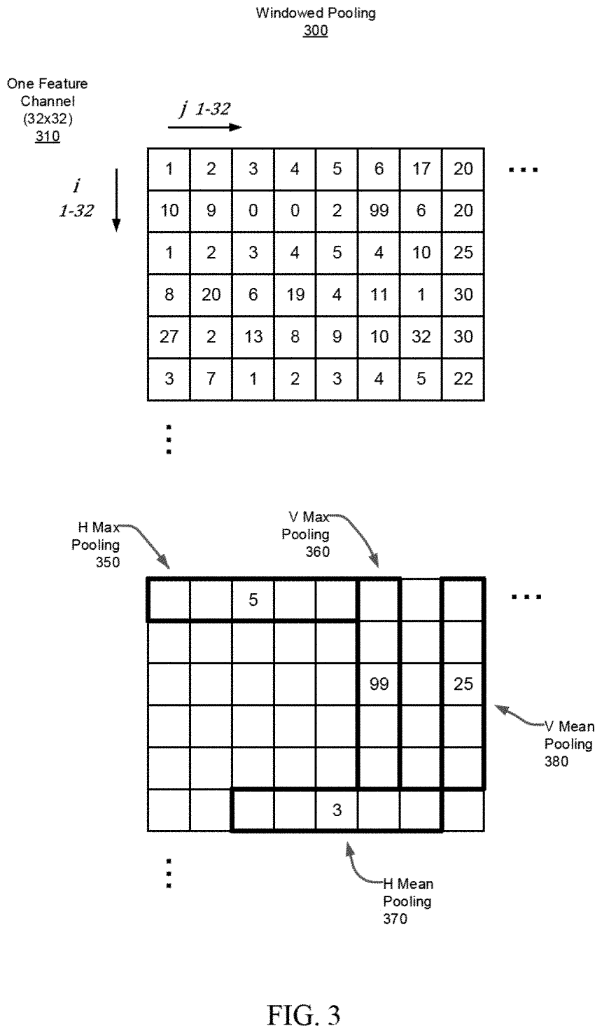

FIG. 3 illustrates examples of windowed pooling 300, in accordance with an embodiment of the present disclosure. As will be explained in greater detail below, the WCP blocks 220 employ a number of windowed pooling operations, some examples of which are illustrated in FIG. 3. An example of one feature channel 310 is shown as an array of 32 by 32 (N×M) elements of the feature type for that channel, indexed by j in the horizontal direction and i in the vertical direction. For illustration clarity, not all 32×32 elements are shown. A variety of different pooling operations may be used to generate pooled values for each element i, j in the channel. For example, horizontal maximum pooling 350, with a pooling kernel length of 5, can be calculated for element (1,3) as the maximum feature value along the first row (i=1), of the 5 elements (j=1 . . . 5), which in this case is equal to 5. Horizontal maximum pooling can be similarly obtained (although not illustrated here) for every element of the feature channel 310 (i.e., the pooling is performed with a stride of one). In some embodiments, horizontal maximum pooling 350 may be calculated according to the following equation (where x is the feature channel 310):

$${H}_{max} ( i , j ) = max ( x ( i - \frac{L}{2} , j ) , … , x ( i + \frac{L}{2} - 1 , j )$$

where L is the pooling kernel length of the pooling operation (e.g., 5 in this example).

As another example, vertical maximum pooling 360 can be calculated for element (3,6) as the maximum feature value along the sixth column (j=6), which in this case is equal to 99. Vertical maximum pooling can be similarly obtained for every element of the feature channel 310. In some embodiments, vertical maximum pooling 360 may be calculated according to the following equation:

$${V}_{max} ( i , j ) = max ( x ( i , j - \frac{L}{2} ) , … , x ( i , j + \frac{L}{2} - 1 )$$

As yet another example, horizontal mean pooling 370 can be calculated for element (6,5) as the average or mean of the feature values along the sixth row (i=6), which in this case is equal to 3. Horizontal mean pooling can be similarly obtained for every element of the feature channel 310. In some embodiments, horizontal mean pooling 370 may be calculated according to the following equation:

$${H}_{m e a n} ( i , j ) = \frac{1}{L} {\sum }_{k = - \frac{L}{2}}^{\frac{L}{2} - 1} x ( i + k , j )$$

As yet another example, vertical mean pooling 380 can be calculated for element (3,8) as the average or mean of the feature values along the eighth column (j=8), which in this case is equal to 25. Vertical mean pooling can be similarly obtained for every element of the feature channel 310. In some embodiments, vertical mean pooling 380 may be calculated according to the following equation:

$${V}_{m e a n} ( i , j ) = \frac{1}{L} {\sum }_{k = - \frac{L}{2}}^{\frac{L}{2} - 1} x ( i , j + k )$$

Other types of pooling operations may also be employed, including, for example, horizontal minimum pooling, vertical minimum pooling, horizontal median pooling, and vertical median pooling, to name just a few.

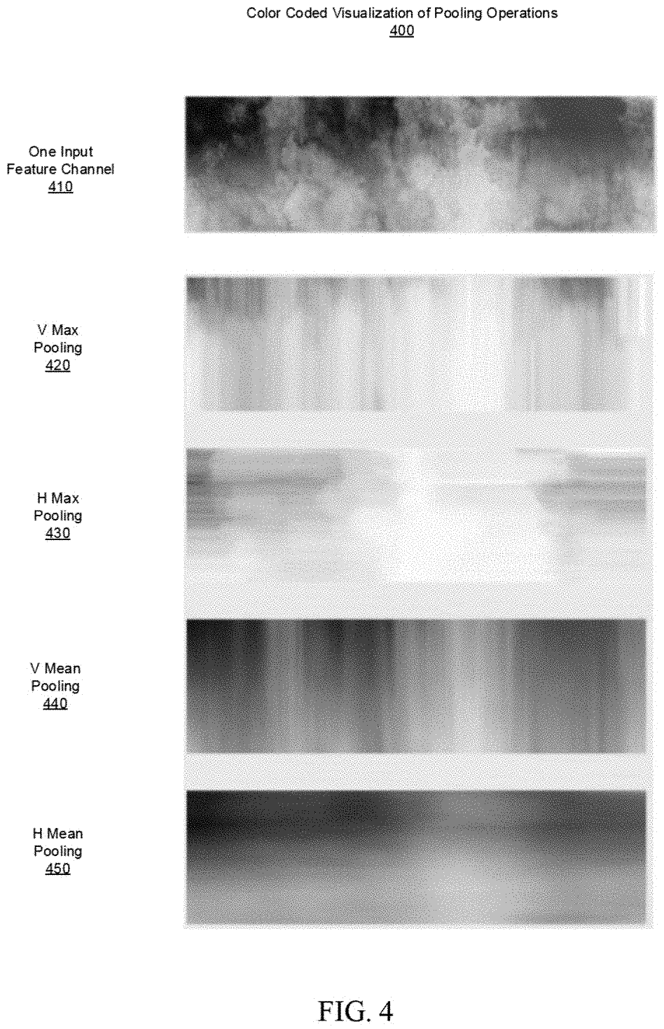

FIG. 4 illustrates a color-coded visualization of pooling operations 400, in accordance with an embodiment of the present disclosure. The color coding provides a visual illustration of the effects of the various pooling processes. An example of one input feature channel 410 is shown in which each element of the feature channel is color coded, which is to say that the value of each element is mapped to a color based on an arbitrary mapping function. For example, small values are mapped to the blue end of the spectrum and large values are mapped to the red end of the spectrum. The effects of vertical max pooling are shown in the second image 420, horizontal max pooling in the third image 430, vertical mean pooling in the fourth image 440, and horizontal mean pooling in the fourth image 450. As can be seen, the pooling effects tend to integrate the values of the feature channel elements over larger distances (in either the horizontal or vertical directions) which increases the receptive field of the network.

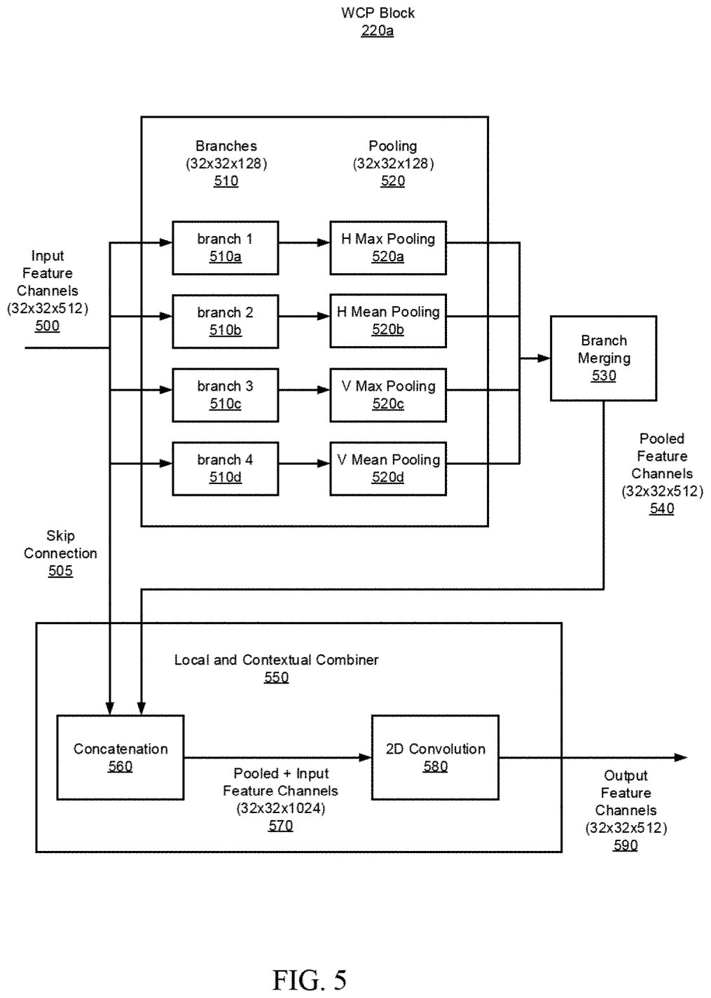

FIG. 5 is a block diagram of an example embodiment of a WCP block 220a, configured in accordance with an embodiment of the present disclosure. The WCP block 220a is shown to include branching modules 510, pooling modules 520, branch merging module 530, and a local and contextual combiner module 550, which comprises a concatenation module 560 and a 2-dimensional convolution network 580.

The branching modules 510 are configured to segment input feature channels 500 into groups (also referred to as branches) of feature channels 510a, 510b, 510c, 510d. In this example there are 512 input feature channels (each of size 32×32), which are segmented into four branches, each branch comprising 128 feature channels (of size 32×32). In some embodiments, the input feature channels may be segmented into branches of different sizes, and the branches may include overlapping feature channels.

The pooling modules 520 are configured to perform windowed pooling operations on each of the branches 510. Pooling module 520a is configured to perform a horizontal maximum pooling operation on the first branch of feature channels 510a. Pooling module 520b is configured to perform a horizontal mean pooling operation on the second branch of feature channels 510b. Pooling module 520c is configured to perform a vertical maximum pooling operation on the third branch of feature channels 510c. Pooling module 520d is configured to perform a vertical mean pooling operation on the fourth branch of feature channels 510d.

The branch merging module 530 is configured to concatenate the pooled branches 520, each of dimension 32×32×128 in this example, together to create the pooled feature channels 540 of dimension 32×32×512. In some embodiments, the pooled branches 520 may be weighted, as described in greater detail below, prior to merging.

While the pooling operations accumulate features over a wide area for context, they can also result in a loss of important local features, as can be seen for example in FIG. 4, where the local feature details visible in 410 are smeared out in 420-450. Local features are the features that are generated from, or associated with, smaller regions of the original image. Local features may thus provide information about relatively smaller objects such as, for example, the laptop 155 in FIG. 1. In contrast, global features are the features that are generated from, or associated with, larger regions of the original image. Global features may thus provide information about relatively larger objects such as, for example, the table 150 in FIG. 1.

For this reason, the local and contextual combiner module 550 is configured to recombine the pooled feature channels 540 with the original input feature channels 500 (which are provided through a skip connection 505). The original input feature channels 500 provide local features details while the pooled feature channels 540 provide global (e.g., contextual) feature details. The combination of local and contextual feature details improves the detection and classification predictions of the downstream convolutional network layers 230.

More specifically, the concatenation module 560 is configured to concatenate the pooled feature channels 540 with the original input feature channels 500 to generate the pooled plus input feature channels 570, of dimension 32×32×1024.

The 2-dimensional convolution network 580 is configured to down sample the pooled plus input feature channels 570 from 1024 channels back down to 512 channels, to match the input to the WCP block. This down sampling generates output feature channels 590 of dimension 32×32×512. It is not required, however, that the dimension of the output feature channels 590 match the dimension of the input feature channels. In some embodiments, the 2-dimensional convolution network 580 may generate an output of any desired dimension. Additionally, in some embodiments, the pooling operations may be performed with a stride greater than one which would alter the output dimensions.

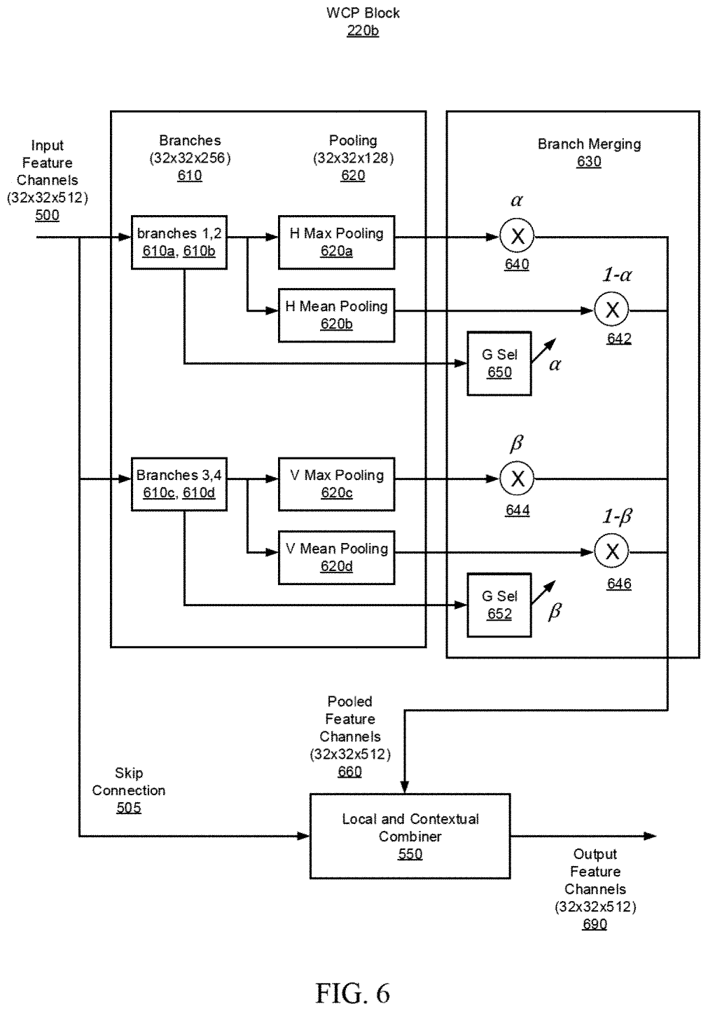

FIG. 6 is a block diagram of another embodiment of a WCP block 220b, configured in accordance with an embodiment of the present disclosure. WCP block 220b operates in a similar manner to the WCP block 220a, as previously described, but incorporates a weighted merging operation with weight factors generated by a gate selection CNN that is trained to provide an optimal (or near optimal) mix of the different pooling operations. The WCP block 220b is shown to include branching modules 610, pooling modules 620, branch merging module 630, and local and contextual combiner module 550.

The branching modules 610 are configured to segment input feature channels 500 into branches of feature channels 610a, 610b, 610c, 610d. In this example there are 512 input feature channels (each of size 32×32), which are segmented into four branches, each branch comprising 128 feature channels (of size 32×32).

The pooling modules 620 are configured to perform windowed pooling operations on each of the branches 610. Pooling module 620a is configured to perform a horizontal maximum pooling operation on the first branch of feature channels 610a. Pooling module 620b is configured to perform a horizontal mean pooling operation on the second branch of feature channels 610b. Pooling module 620c is configured to perform a vertical maximum pooling operation on the third branch of feature channels 610c. Pooling module 620d is configured to perform a vertical mean pooling operation on the fourth branch of feature channels 610d.

The branch merging module 630 is configured to perform a weighted merging of the pooled branches 620, each of dimension 32×32×128 in this example, together to create the pooled feature channels 660 of dimension 32×32×512.

Gate selection CNN 650 is trained to generate a vector of weighting factors α. In this example the length of the vector α is 128, so that there is one weight factor for each of the 128 feature channels of each pooling branch. The feature channels of the horizontal max pooling branch 620a are weighted by α through multiplier 640, and the feature channels of the horizontal mean pooling branch 620b are weighted by 1-α through multiplier 642.

Similarly, gate selection CNN 652 is trained to generate a vector of weighting factors β. In this example the length of the vector β is 128, so that there is one weight factor for each of the 128 feature channels of each pooling branch. The feature channels of the vertical max pooling branch 620c are weighted by β through multiplier 644, and the feature channels of the vertical mean pooling branch 620d are weighted by 1-β through multiplier 646.

The learned weights α and β provide the ability for the network to emphasize those features that are most important for making good predictions and to de-emphasize the features that are less important.

In this example, the horizontal pooling operations are gated separately from the vertical pooling operations (e.g., gate selection CNNs 650 and 652). In some embodiments, however, a single gate selection CNN may be used to provide relative weighting between all pooling operations.

The local and contextual combiner module 550 is configured, as previously described, to recombine the pooled feature channels 660 with the original input feature channels 500 to generate output feature channels 690 of dimension 32×32×512.

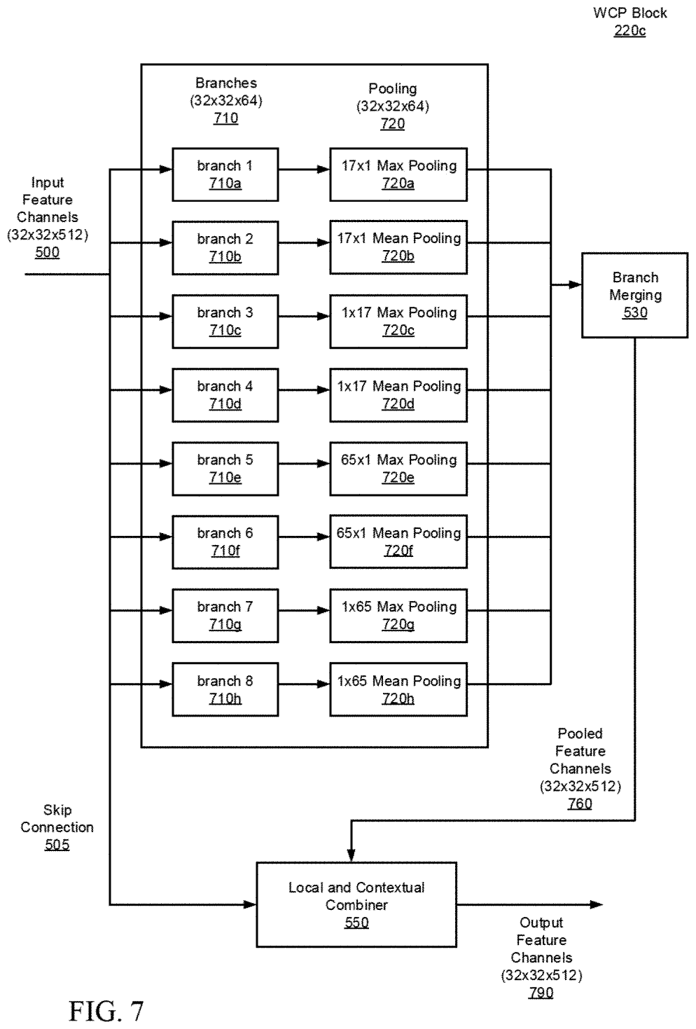

FIG. 7 is a block diagram of yet another embodiment of a WCP block 220c, configured in accordance with an embodiment of the present disclosure. WCP block 220c operates in a similar manner to the WCP block 220a, as previously described, but utilizes two groups of four branches for a total of eight branches and illustrates the implementation of different sized pooling kernels. The first group of four branches (a-d) use a pooling kernel size of 17, while the second group of 4 branches (e-h) use a pooling kernel size of 65. It will be understood that these kernel sizes are chosen as examples, and other sizes are possible. The WCP block 220b is shown to include branching modules 710, pooling modules 720, branch merging module 530, and local and contextual combiner module 550.

The branching modules 710 are configured to segment input feature channels 500 into branches of feature channels 710a, . . . 710h. In this example there are 512 input feature channels (each of size 32×32), which are segmented into eight branches, each branch comprising 64 feature channels (of size 32×32).

The pooling modules 720 are configured to perform windowed pooling operations on each of the branches 710. Pooling module 720a is configured to perform a horizontal maximum pooling operation on the first branch of feature channels 710a using a pooling kernel of size 17×1. Pooling module 720b is configured to perform a horizontal mean pooling operation on the second branch of feature channels 710b using a pooling kernel of size 17×1. Pooling module 720c is configured to perform a vertical maximum pooling operation on the third branch of feature channels 710c using a pooling kernel of size 1×17. Pooling module 720d is configured to perform a vertical mean pooling operation on the fourth branch of feature channels 710d using a pooling kernel of size 1×17. Pooling module 720e is configured to perform a horizontal maximum pooling operation on the fifth branch of feature channels 710e using a pooling kernel of size 65×1. Pooling module 720f is configured to perform a horizontal mean pooling operation on the sixth branch of feature channels 710f using a pooling kernel of size 65×1. Pooling module 720g is configured to perform a vertical maximum pooling operation on the seventh branch of feature channels 710g using a pooling kernel of size 1×65. Pooling module 720h is configured to perform a vertical mean pooling operation on the eighth branch of feature channels 710h using a pooling kernel of size 1×65. The choice of pooling kernel sizes can be made empirically, based on experimental results, and the size can be implemented as a hyper-parameter of the system.

The branch merging module 530 is configured, as previously described, to concatenate the pooled branches 720, each of dimension 32×32×64 in this example, together to create the pooled feature channels 760 of dimension 32×32×512. In some embodiments, the pooled branches 760 may be weighted, as previously described in connection with FIG. 6 above, prior to merging.

The local and contextual combiner module 550 is configured, as previously described, to recombine the pooled feature channels 760 with the original input feature channels 500 to generate output feature channels 790 of dimension 32×32×512.

Methodology

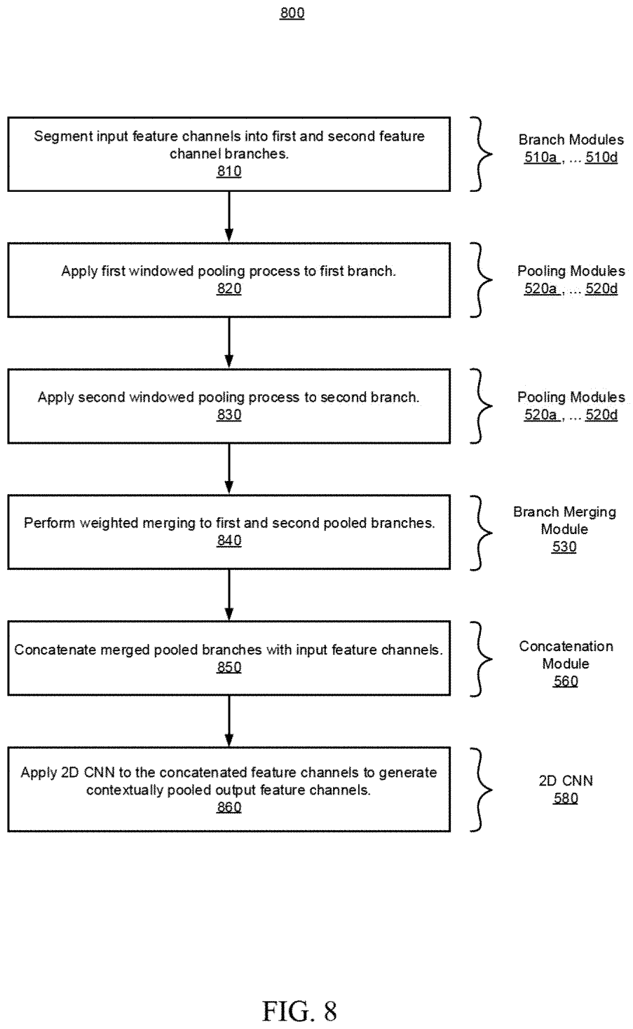

FIG. 8 is a flowchart illustrating a method 800 for performing WCP, in accordance with an embodiment of the present disclosure. As can be seen, the method is described with reference to the configuration of the neural network employing WCP 120 of FIGS. 1, 2, and 5-7. However, any number of module configurations can be used to implement the method, as will be appreciated in light of this disclosure. Further note that the various functions depicted in the method do not need to be assigned to the specific example modules shown. To this end, the example methodology depicted is provided to give one example embodiment and is not intended to limit the methodology to any particular physical or structural configuration; rather, the feedback-based techniques provided herein can be used with a number of architectures and platforms and variations, as will be appreciated.

The method commences, at operation 810, by segmenting input feature channels into a first group of feature channels and a second group of feature channels. In some embodiments, the input feature channels are generated by a backbone CNN applied to an input image. In some embodiments, the input feature channels are provided by another WCP block.

The method continues, at operation 820, by applying a first windowed pooling process to the first group of feature channels to generate a first group of pooled feature channels. At operation 830, a second windowed pooling process is applied to the second group of feature channels to generate a second group of pooled feature channels. In some embodiments, the windowed pooling processes may be horizontal maximum pooling, horizontal minimum pooling, horizontal mean pooling, vertical maximum pooling, vertical minimum pooling, or vertical mean pooling, although other types of pooling are possible, including median pooling and quartile pooling. In some embodiments, the pooling kernel length is greater than 16.

At operation 840, a weighted merging of the first group of pooled feature channels and the second group of pooled feature channels is performed to generate merged pooled feature channels. In some embodiments, the weighted merging is performed with weighting factors generated by a gate selection CNN.

At operation 850, the merged pooled feature channels are concatenated with the input feature channels to generate concatenated feature channels.

At operation 860, a two-dimensional convolutional neural network (CNN) is applied to the concatenated feature channels to generate contextually pooled output feature channels. In some embodiments, the contextually pooled output feature channels are applied to another WCP block. In some embodiments, the contextually pooled output feature channels are applied to an output CNN that is trained to generate an object bounding box or detection and/or generate a class prediction for one or more objects in the input image.

Example Platform

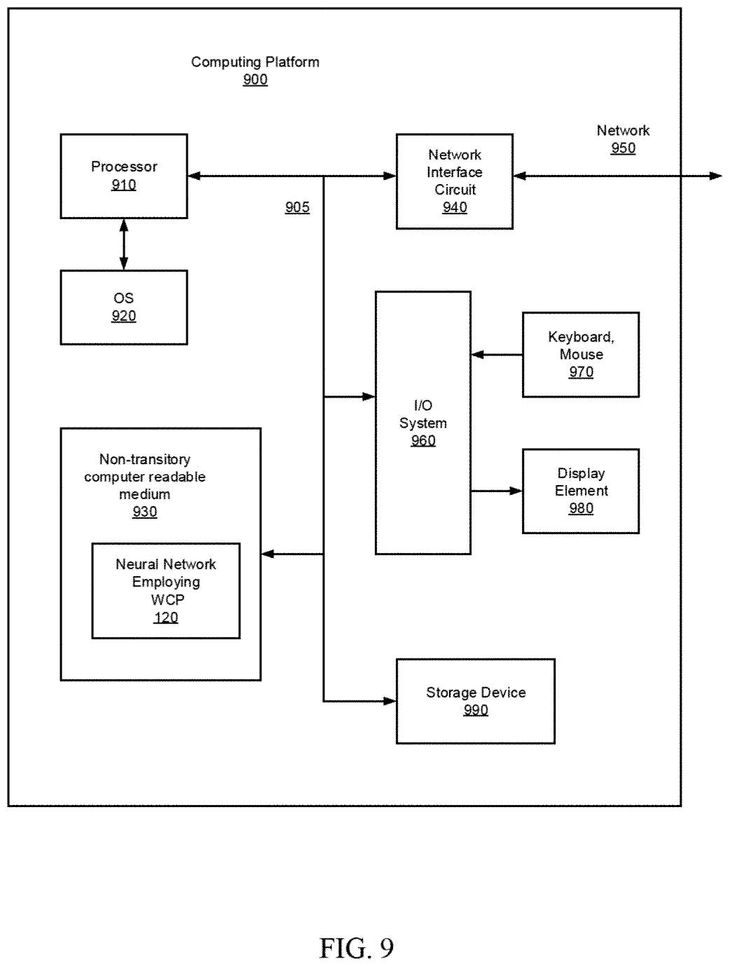

FIG. 9 is a block diagram schematically illustrating a computing platform 900 configured to perform any of the techniques as variously described in this disclosure, configured in accordance with an embodiment of the present disclosure. For example, in some embodiments, the neural network employing WCP 120 of FIG. 1, or any portions thereof as illustrated in FIGS. 2, and 5-7, and the methodology of FIG. 8, or any portions thereof, are implemented in the computing platform 900. In some embodiments, the computing platform 900 is a computer system, such as a workstation, desktop computer, server, laptop, handheld computer, tablet computer (e.g., the iPad tablet computer), mobile computing or communication device (e.g., the iPhone mobile communication device, the Android mobile communication device, and the like), or other form of computing device that has sufficient processor power and memory capacity to perform the operations described in this disclosure. In some embodiments, a distributed computational system is provided comprising a plurality of such computing devices.

The computing platform 900 includes one or more storage devices 990 and/or non-transitory computer-readable media 930 having encoded thereon one or more computer-executable instructions or software for implementing techniques as variously described in this disclosure. In some embodiments, the storage devices 990 include a computer system memory or random-access memory, such as a durable disk storage (e.g., any suitable optical or magnetic durable storage device, including RAM, ROM, Flash, USB drive, or other semiconductor-based storage medium), a hard-drive, CD-ROM, or other computer readable media, for storing data and computer-readable instructions and/or software that implement various embodiments as taught in this disclosure. In some embodiments, the storage device 990 includes other types of memory as well, or combinations thereof. In one embodiment, the storage device 990 is provided on the computing platform 900. In another embodiment, the storage device 990 is provided separately or remotely from the computing platform 900. The non-transitory computer-readable media 930 include, but are not limited to, one or more types of hardware memory, non-transitory tangible media (for example, one or more magnetic storage disks, one or more optical disks, one or more USB flash drives), and the like. In some embodiments, the non-transitory computer-readable media 930 included in the computing platform 900 store computer-readable and computer-executable instructions or software for implementing various embodiments. In one embodiment, the computer-readable media 930 are provided on the computing platform 900. In another embodiment, the computer-readable media 930 are provided separately or remotely from the computing platform 900.

The computing platform 900 also includes at least one processor 910 for executing computer-readable and computer-executable instructions or software stored in the storage device 990 and/or non-transitory computer-readable media 930 and other programs for controlling system hardware. In some embodiments, virtualization is employed in the computing platform 900 so that infrastructure and resources in the computing platform 900 are shared dynamically. For example, a virtual machine is provided to handle a process running on multiple processors so that the process appears to be using only one computing resource rather than multiple computing resources. In some embodiments, multiple virtual machines are used with one processor.

As can be further seen, a bus or interconnect 905 is also provided to allow for communication between the various components listed above and/or other components not shown. Computing platform 900 can be coupled to a network 950 (e.g., a local or wide area network such as the internet), through network interface circuit 940 to allow for communications with other computing devices, platforms, resources, clients, and Internet of Things (IoT) devices.

In some embodiments, a user interacts with the computing platform 900 through an input/output system 960 that interfaces with devices such as a keyboard and mouse 970 and/or a display element (screen/monitor) 980. The keyboard and mouse may be configured to provide a user interface to accept user input and guidance, and to otherwise control a system employing neural network 120. The display element may be configured, for example, to display the results of image processing (e.g., bounding boxes, object detection, object classification, etc.) using the disclosed techniques. In some embodiments, the computing platform 900 includes other I/O devices (not shown) for receiving input from a user, for example, a pointing device or a touchpad, etc., or any suitable user interface. In some embodiments, the computing platform 900 includes other suitable conventional I/O peripherals. The computing platform 900 can include and/or be operatively coupled to various suitable devices for performing one or more of the aspects as variously described in this disclosure.

In some embodiments, the computing platform 900 runs an operating system (OS) 920, such as any of the versions of Microsoft Windows operating systems, the different releases of the Unix and Linux operating systems, any version of the MacOS for Macintosh computers, any embedded operating system, any real-time operating system, any open source operating system, any proprietary operating system, any operating systems for mobile computing devices, or any other operating system capable of running on the computing platform 900 and performing the operations described in this disclosure. In one embodiment, the operating system runs on one or more cloud machine instances.

As will be appreciated in light of this disclosure, the various modules and components of the system, as shown in FIGS. 2, 4, 6, and 7, can be implemented in software, such as a set of instructions (e.g., HTML, XML, C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided in this disclosure to be carried out. It will be appreciated that, in some embodiments, various functions and data transformations performed by the computing system, as described in this disclosure, can be performed by similar processors in different configurations and arrangements, and that the depicted embodiments are not intended to be limiting. Various components of this example embodiment, including the computing platform 900, can be integrated into, for example, one or more desktop or laptop computers, workstations, tablets, smart phones, game consoles, set-top boxes, or other such computing devices. Other componentry and modules typical of a computing system, such as, for example a co-processor, a processing core, a graphics processing unit, a touch pad, a touch screen, etc., are not shown but will be readily apparent.

In other embodiments, the functional components/modules are implemented with hardware, such as gate level logic (e.g., FPGA) or a purpose-built semiconductor (e.g., ASIC). Still other embodiments are implemented with a microcontroller having a number of input/output ports for receiving and outputting data, and a number of embedded routines for carrying out the functionality described in this disclosure. In a more general sense, any suitable combination of hardware, software, and firmware can be used, as will be apparent.

### Further Example Embodiments

Numerous example embodiments will be apparent, and features described herein can be combined in any number of configurations.

Example 1 is a method for contextual pooling to increase global context of features for processing by a neural network, the method comprising: segmenting, by a processor-based system, input feature channels into a first group of feature channels and a second group of feature channels; applying, by the processor-based system, a first windowed pooling process to the first group of feature channels to generate a first group of pooled feature channels; applying, by the processor-based system, a second windowed pooling process to the second group of feature channels to generate a second group of pooled feature channels; performing, by the processor-based system, a weighted merging of the first group of pooled feature channels and the second group of pooled feature channels to generate merged pooled feature channels; concatenating, by the processor-based system, the merged pooled feature channels with the input feature channels to generate concatenated feature channels; and applying, by the processor-based system, a two-dimensional convolutional neural network (CNN) to the concatenated feature channels to generate contextually pooled output feature channels.

Example 2 includes the subject matter of Example 1, wherein the first windowed pooling process is a maximum pooling process or a minimum pooling process, and the second windowed pooling process is a mean pooling process.

Example 3 includes the subject matter of Examples 1 or 2, wherein the first windowed pooling process employs a first pooling kernel of length greater than 16 and the second windowed pooling process employs a second pooling kernel of length greater than 16.

Example 4 includes the subject matter of any of Examples 1-3, wherein the weighted merging is performed with weighting factors generated by a gate selection CNN.

Example 5 includes the subject matter of any of Examples 1-4, wherein the input feature channels are generated by a backbone CNN applied to an input image.

Example 6 includes the subject matter of any of Examples 1-5, wherein the input feature channels are generated by a contextual pooling process.

Example 7 includes the subject matter of any of Examples 1-6, further comprising: applying a backbone CNN to an input image to generate the input feature channels; and applying the contextually pooled output feature channels to an output CNN to generate a detection and/or a class prediction for one or more objects in the input image.

Example 8 is a system for contextual pooling to increase global context of features for processing by a neural network, the system comprising: one or more processors configured to segment input feature channels into a first group of feature channels and a second group of feature channels; the one or more processors further configured to apply a first windowed pooling process to the first group of feature channels to generate a first group of pooled feature channels; the one or more processors further configured to apply a second windowed pooling process to the second group of feature channels to generate a second group of pooled feature channels; the one or more processors further configured to perform a weighted merging of the first group of pooled feature channels and the second group of pooled feature channels to generate merged pooled feature channels; the one or more processors further configured to concatenate the merged pooled feature channels with the input feature channels to generate concatenated feature channels; the one or more processors further configured to apply a two-dimensional convolutional neural network (CNN) to the concatenated feature channels to generate contextually pooled output feature channels; and the one or more processors further configured to apply the contextually pooled output feature channels to an output neural network to generate a detection and/or a class prediction for one or more objects in the input image.

Example 9 includes the subject matter of Example 8, wherein the first windowed pooling process is a maximum pooling process or a minimum pooling process, and the second windowed pooling process is a mean pooling process.

Example 10 includes the subject matter of Examples 8 or 9, wherein the first windowed pooling process employs a first pooling kernel of length greater than 16 and the second windowed pooling process employs a second pooling kernel of length greater than 16.

Example 11 includes the subject matter of any of Examples 8-10, wherein the weighted merging is performed with weighting factors generated by a gate selection CNN.

Example 12 includes the subject matter of any of Examples 8-11, wherein the system for contextual pooling is a first system for contextual pooling and the input feature channels are generated by a second system for contextual pooling.

Example 13 includes the subject matter of any of Examples 8-12, wherein the input feature channels are generated by a backbone CNN applied to an input image and the output neural network to which the contextually pooled output feature channels are applied comprises an output CNN to generate the detection and/or a class prediction for one or more objects in the input image.

Example 14 is a computer program product including one or more non-transitory machine-readable mediums encoded with instructions that when executed by one or more processors cause a process to be carried out for contextual pooling, the process comprising: segmenting input feature channels into a first group of feature channels and a second group of feature channels; applying a first windowed pooling process to the first group of feature channels to generate a first group of pooled feature channels; applying a second windowed pooling process to the second group of feature channels to generate a second group of pooled feature channels; performing a weighted merging of the first group of pooled feature channels and the second group of pooled feature channels to generate merged pooled feature channels; concatenating the merged pooled feature channels with the input feature channels to generate concatenated feature channels; and applying a two-dimensional convolutional neural network (CNN) to the concatenated feature channels to generate contextually pooled output feature channels.

Example 15 includes the subject matter of Example 14, wherein the first windowed pooling process is a maximum pooling process or a minimum pooling process, and the second windowed pooling process is a mean pooling process.

Example 16 includes the subject matter of Example 14 or 15, wherein the first windowed pooling process employs a first pooling kernel of length greater than 16 and the second windowed pooling process employs a second pooling kernel of length greater than 16.

Example 17 includes the subject matter of any of Examples 14-16, wherein the weighted merging is performed with weighting factors generated by a gate selection CNN.

Example 18 includes the subject matter of any of Examples 14-17, wherein the input feature channels are generated by a backbone CNN applied to an input image.

Example 19 includes the subject matter of any of Examples 14-18, wherein the input feature channels are generated by a contextual pooling process.

Example 20 includes the subject matter of any of Examples 14-19, wherein the process further comprises: applying a backbone CNN to an input image to generate the input feature channels; and applying the contextually pooled output feature channels to an output CNN to generate a detection and/or a class prediction for one or more objects in the input image.

The foregoing description of example embodiments of the disclosure has been presented for the purposes of illustration and description. It is not intended to be exhaustive or to limit the disclosure to the precise forms disclosed. Many modifications and variations are possible in light of this disclosure. It is intended that the scope of the disclosure be limited not by this detailed description, but rather by the claims appended hereto.

What is claimed is:

1. A method for contextual pooling to increase global context of features for processing by a neural network, the method comprising:
segmenting, by a processor-based system, input feature channels into a first group of feature channels and a second group of feature channels;
applying, by the processor-based system, a first windowed pooling process to the first group of feature channels to generate a first group of pooled feature channels;
applying, by the processor-based system, a second windowed pooling process to the second group of feature channels to generate a second group of pooled feature channels;
performing, by the processor-based system, a weighted merging of the first group of pooled feature channels and the second group of pooled feature channels to generate merged pooled feature channels;
concatenating, by the processor-based system, the merged pooled feature channels with the input feature channels to generate concatenated feature channels; and
applying, by the processor-based system, a two-dimensional convolutional neural network (CNN) to the concatenated feature channels to generate contextually pooled output feature channels.

2. The method of claim 1, wherein the first windowed pooling process is a maximum pooling process or a minimum pooling process, and the second windowed pooling process is a mean pooling process.

3. The method of claim 1, wherein the first windowed pooling process employs a first pooling kernel of length greater than 16 and the second windowed pooling process employs a second pooling kernel of length greater than 16.

4. The method of claim 1, wherein the weighted merging is performed with weighting factors generated by a gate selection CNN.

5. The method of claim 1, wherein the input feature channels are generated by a backbone CNN applied to an input image.

6. The method of claim 1, wherein the input feature channels are generated by a contextual pooling process.

7. The method of claim 1, further comprising:
applying a backbone CNN to an input image to generate the input feature channels; and
applying the contextually pooled output feature channels to an output CNN to generate a detection and/or a class prediction for one or more objects in the input image.

8. A system for contextual pooling to increase global context of features for processing by a neural network, the system comprising:
one or more processors configured to segment input feature channels into a first group of feature channels and a second group of feature channels;
the one or more processors further configured to apply a first windowed pooling process to the first group of feature channels to generate a first group of pooled feature channels;
the one or more processors further configured to apply a second windowed pooling process to the second group of feature channels to generate a second group of pooled feature channels;
the one or more processors further configured to perform a weighted merging of the first group of pooled feature channels and the second group of pooled feature channels to generate merged pooled feature channels;
the one or more processors further configured to concatenate the merged pooled feature channels with the input feature channels to generate concatenated feature channels;
the one or more processors further configured to apply a two-dimensional convolutional neural network (CNN) to the concatenated feature channels to generate contextually pooled output feature channels; and
the one or more processors further configured to apply the contextually pooled output feature channels to an output neural network to generate a detection and/or a class prediction for one or more objects in the input image.

9. The system of claim 8, wherein the first windowed pooling process is a maximum pooling process or a minimum pooling process, and the second windowed pooling process is a mean pooling process.

10. The system of claim 8, wherein the first windowed pooling process employs a first pooling kernel of length greater than 16 and the second windowed pooling process employs a second pooling kernel of length greater than 16.

11. The system of claim 8, wherein the weighted merging is performed with weighting factors generated by a gate selection CNN.

12. The system of claim 8, wherein the system for contextual pooling is a first system for contextual pooling and the input feature channels are generated by a second system for contextual pooling.

13. The system of claim 8, wherein the input feature channels are generated by a backbone CNN applied to an input image and the output neural network to which the contextually pooled output feature channels are applied comprises an output CNN to generate the detection and/or a class prediction for one or more objects in the input image.

14. A computer program product including one or more non-transitory machine-readable mediums encoded with instructions that when executed by one or more processors cause a process to be carried out for contextual pooling, the process comprising:
segmenting input feature channels into a first group of feature channels and a second group of feature channels;
applying a first windowed pooling process to the first group of feature channels to generate a first group of pooled feature channels;
applying a second windowed pooling process to the second group of feature channels to generate a second group of pooled feature channels;
performing a weighted merging of the first group of pooled feature channels and the second group of pooled feature channels to generate merged pooled feature channels;
concatenating the merged pooled feature channels with the input feature channels to generate concatenated feature channels; and
applying a two-dimensional convolutional neural network (CNN) to the concatenated feature channels to generate contextually pooled output feature channels.

15. The computer program product of claim 14, wherein the first windowed pooling process is a maximum pooling process or a minimum pooling process, and the second windowed pooling process is a mean pooling process.

16. The computer program product of claim 14, wherein the first windowed pooling process employs a first pooling kernel of length greater than 16 and the second windowed pooling process employs a second pooling kernel of length greater than 16.

17. The computer program product of claim 14, wherein the weighted merging is performed with weighting factors generated by a gate selection CNN.

18. The computer program product of claim 14, wherein the input feature channels are generated by a backbone CNN applied to an input image.

19. The computer program product of claim 14, wherein the input feature channels are generated by a contextual pooling process.

20. The computer program product of claim 14, wherein the process further comprises:
applying a backbone CNN to an input image to generate the input feature channels; and
applying the contextually pooled output feature channels to an output CNN to generate a detection and/or a class prediction for one or more objects in the input image.
